(19) United States
(12) Patent Application Publication
(10) Pub. No.: US 2010/0271258 A1
(43) Pub. Date: Oct. 28, 2010

(54) RADAR DEVICE

(75) Inventors: Yuki TAKABAYASHI, Tokyo (JP); Hiroshi Kameda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/574,070

(22) Filed: Oct. 6, 2009

(30) Foreign Application Priority Data
Apr. 22, 2009 (JP) 2009-104154

(51) Int. Cl. G01S 13/58; G01S 13/42; G01S 13/32

(52) U.S. Cl. 342/107; 342/200

(57) ABSTRACT

A radar device includes: a signal processor that receives an FMCW signal, detects a peak of a beat signal according to a reception signal and a transmission signal, and performs a correspondence of the beat frequency and an angle measurement process to generate target information; a beat frequency tracking filter that receives the beat frequency and updates a position and a velocity of the target; a pair observation value tracking filter that receives the observation value of the position and the velocity of the target to update the position and the velocity of the target; an integration/selection unit that integrates the tracks of both the tracking filters together or selects one thereof; a system track memory; and an abnormal value determination unit.

### BACKGROUND OF THE INVENTION

1. Field of the Invention

The present invention relates to a radar device such as a frequency modulated continuous wave (FMCW) radar device used for anticollision of a moving object such as an automobile, preceding-vehicle following travel while keeping a constant inter-vehicle range, or the like, for detecting a relative velocity or a range with respect to a target existing outside the moving object through transmission and reception of a radar wave.

2. Description of the Related Art

As illustrated in FIG. 12, a conventional radar device transmits, as a radar wave, a transmission signal S1 which is modulated in frequency by a modulated signal of a triangle wave to have a frequency repetitively increased and decreased in a given period. Then, the radar device receives the radar wave reflected from a target, and mixes a reception signal S2 with the transmission signal S1 to generate a beat signal S3. Then, the radar device specifies a frequency (beat frequency) of the beat signal S3 in each sweep interval of an up-chirp state in which the frequency of the transmission signal S1 increases, and a down-chirp state in which the frequency decreases. The radar device calculates a range R and a relative velocity V with respect to the target with the use of the following expressions (91) and (92) on the basis of a specified beat frequency f^{u} in the up-chirp state and a specified beat frequency f^{d} in the down-chirp state.

$$\begin{matrix}R = \frac{cT}{4 B} ( {f}^{u} + {f}^{d} ) & ( 91 ) \\ V = \frac{c}{4 {f}_{0}} ( {f}^{u} - {f}^{d} ) & ( 92 )\end{matrix}$$

where B is a frequency displacement width of the transmission signal S1, f₀ is a center frequency of the transmission signal S1, T is a period of time required for modulation in one period, and C is a light speed.

As described above, the conventional radar device is capable of detecting the range to the target and a range change rate through association (hereinafter, referred to as “pairing”) of the beat frequencies in the up-chirp state and the down-chirp state with each other. The beat frequencies obtained in the up-chirp state and the down-chirp state, respectively, are offset to each other even if the beat frequencies are obtained for the same target. In particular, under the environment in which there exist a plurality of targets, that is, a plurality of beat frequencies, there is a need to determine which beat frequency in the up-chirp state corresponds to the beat frequency in the down-chirp state, and the determination is extremely difficult.

As a countermeasure against the above-mentioned problem, there has been proposed the following FMCW radar device (for example, see Japanese Patent No. 2778864). The conventional FMCW radar device is capable of coping with the environment in which the plurality of targets exist, in such a manner that, in pairing of the beat frequencies obtained in the up-chirp state and the down-chirp state, pairing of the beat frequencies obtained in the up-chirp state and the down-chirp state is performed so that the beat frequencies obtained in each sweep period are arranged in ascending order, and the arrangement is saved.

However, the above-mentioned conventional technology requires pairing of the beat frequencies obtained in the up-chirp state and the down-chirp state with an aim to obtain the range and the velocity with respect to the external target. For that reason, when the frequency in one of those states is not obtained, there appears a target (undetectable target) which cannot be detected because the frequency pair cannot be selected though the target actually exists, or a target (false target) which would not originally exist. This causes reliability of measurement results to deteriorate.

To solve the above-mentioned drawbacks, there has been proposed the following method (for example, see Japanese Patent No. 4186744). In the proposed method, when a given target is first observed, the beat frequencies obtained in the up-chirp state and the down-chirp state are paired with each other to obtain the range to the target and the range change rate. In second and subsequent observations, the range and the range change rate which have been first obtained, and the beat frequency in the up-chirp state or the down-chirp state are directly employed to calculate the range to the target and the range change rate.

However, the conventional technology suffers from the following problems. The conventional radar device disclosed in Japanese Patent No. 4186744 does not require pairing of the beat frequencies, but updates the range and the range change rate without consideration of input of an angle. Therefore, when the angle of the target is changed, the probability that a precision in tracking the target position deteriorates is high. Further, a method of removing an erroneous pair in pairing of the beat frequencies for use in a normal radar device is not taken.

### SUMMARY OF THE INVENTION

The present invention has been made to solve the above-mentioned problems, and therefore aims at providing a radar device which is capable of improving a precision in tracking a target even if the number of peaks is different in beat frequency between an up-chirp state and a down-chirp state, and of removing an erroneous pair, by using a tracking filter that receives the beat frequencies together with a tracking filter that receives an observation value after pairing.

In particular, according to the conventional technologies, there has been proposed the method of updating the range and the range change rate with a direct input of the beat frequencies in the up-chirp state and the down-chirp state. On the other hand, the present invention proposes a method of estimating the target position accurately to remove the erroneous pair.

A radar device according to the present invention includes: a receiver that receives, as a reception signal, a signal obtained by reflecting a transmission signal periodically increased or decreased in frequency with a constant modulation width by a target; and a beat frequency detector, which is configured to: mix the reception signal and the transmission signal together to generate a beat signal; obtain a first beat frequency distribution according to the beat signal being in an up-chirp state in which the frequency of the transmission signal increases, to thereby specify a first frequency peak of the first beat frequency distribution; and to obtain a second beat frequency distribution according to the beat signal being in a down-chirp state in which the frequency of the transmission signal decreases, to thereby specify a second frequency peak of the second beat frequency distribution. Further, the radar device of the present invention includes: a beat frequency pair selector that produces a pair observation value of the first frequency peak of the first beat frequency distribution and the second frequency peak of the second beat frequency distribution to calculate a range and a Doppler velocity with respect to the target; and an angle measurement processor that calculates an angle of the target based on the pair observation value. Still further, the radar device of the present invention includes: a pair observation value tracking filter that updates a position and a velocity of a track according to the pair observation value including the range, the Doppler velocity, and the angle by means of an existing track; and a beat frequency tracking filter that updates the position and the velocity of the track according to one of the first frequency peak and the second frequency peak by means of the existing track. Yet further, the radar device of the present invention includes: an integration/selection unit that one of integrates the track of the pair observation value tracking filter and the track of the beat frequency tracking filter together, and selects one of the track of the pair observation value tracking filter and the track of the beat frequency tracking filter, as a system track; a system track memory that stores the system track therein; and an abnormal value determination unit that determines, when the pair observation value from the angle measurement processor is not identical with the system track stored in the system track memory, the pair observation value as an abnormal value, and starts no tracking with respect to the abnormal value.

According to the radar device of the present invention, the tracking filter that receives the beat frequencies and the tracking filter that receives the observation value after pairing are used together, thereby enabling the precision in tracking the target to be improved even when the number of peaks in beat frequency is different between the up-chirp state and the down-chirp state, and the erroneous pair to be removed.

### BRIEF DESCRIPTION OF THE DRAWINGS

In the accompanying drawings:

FIG. 1 is a block diagram illustrating a configuration of a radar device according to a first embodiment of the present invention;

FIG. 2 is a diagram illustrating an observation schedule of the radar device according to the first embodiment of the present invention;

FIG. 3 is a block diagram illustrating a configuration of an up-chirp tracking filter included in a beat frequency tracking filter of the radar device according to the first embodiment of the present invention;

FIG. 4 is a block diagram illustrating a configuration of a pair observation value tracking filter of the radar device according to the first embodiment of the present invention;

FIG. 5 is a flowchart illustrating an operation of an integration/selection unit of the radar device according to the first embodiment of the present invention;

FIG. 6 is a flowchart illustrating the operation of the integration/selection unit of the radar device according to the first embodiment of the present invention;

FIG. 7 is a flowchart illustrating the operation of the integration/selection unit of the radar device according to the first embodiment of the present invention;

FIG. 8 is a block diagram illustrating a configuration of a radar device according to a second embodiment of the present invention;

FIG. 9 is a block diagram illustrating a configuration of an angle tracking filter of the radar device according to the second embodiment of the present invention;

FIG. 10 is a block diagram illustrating a configuration of a radar device according to a third embodiment of the present invention;

FIG. 11 is a block diagram illustrating a configuration of an up-chirp angle tracking filter of the radar device according to the third embodiment of the present invention; and

FIG. 12 is a timing chart illustrating an operation of a conventional radar device.

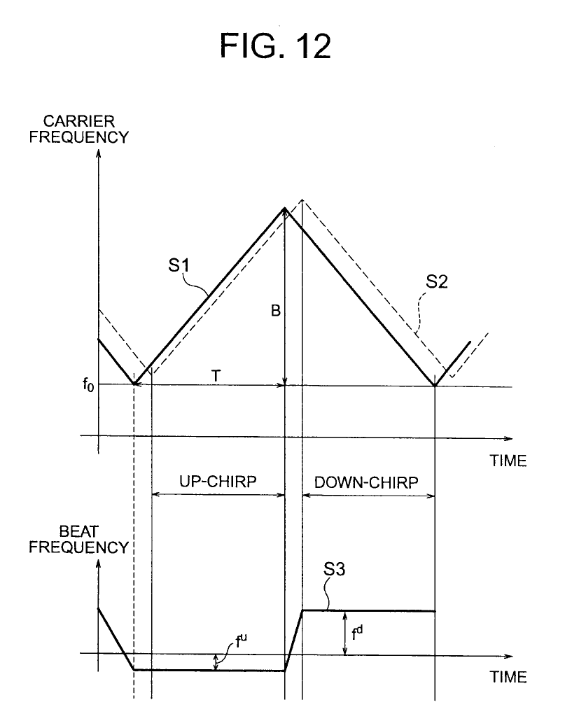

### DETAILED DESCRIPTION OF THE PREFERRED EMBODIMENTS

Hereinafter, a description is given of a radar device according to preferred embodiments of the present invention with reference to the accompanying drawings.

### First Embodiment

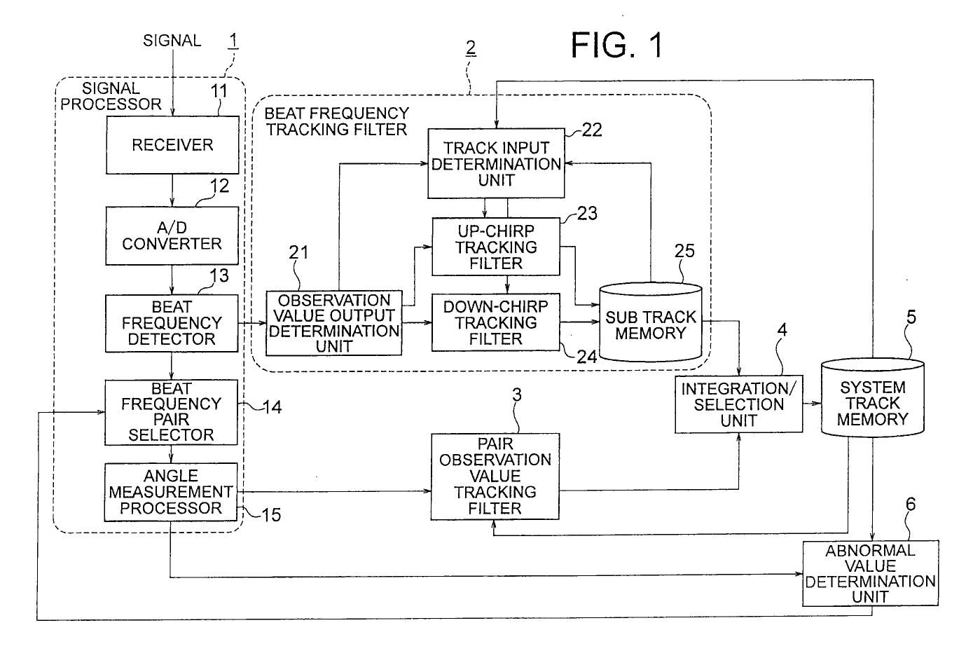

A radar device according to a first embodiment of the present invention is described with reference to FIGS. 1 to 7. FIG. 1 is a block diagram illustrating a configuration of the radar device according to the first embodiment of the present invention. In the following description, identical symbols denote the same or like parts in the respective drawings.

Referring to FIG. 1, the radar device according to the first embodiment of the present invention includes a signal processor 1, a beat frequency tracking filter 2, a pair observation value tracking filter 3, an integration/selection unit 4, a system track memory 5, and an abnormal value determination unit 6.

The signal processor 1 includes a receiver 11, an A/D converter 12, a beat frequency detector 13, a beat frequency pair selector 14, and an angle measurement processor 15.

The beat frequency tracking filter 2 includes an observation value output determination unit 21, a track input determination unit 22, an up-chirp tracking filter 23, a down-chirp tracking filter 24, and a sub track memory 25.

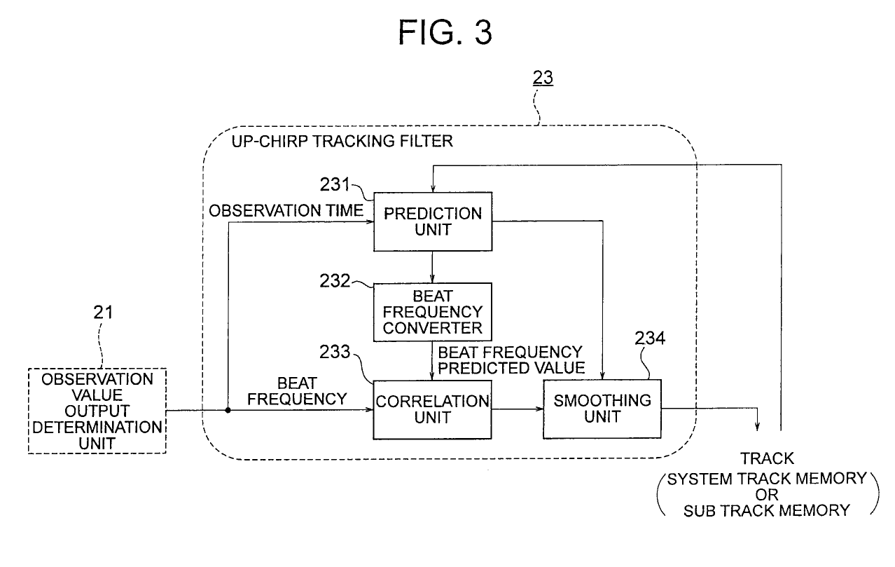

FIG. 3 is a block diagram illustrating a configuration of the up-chirp tracking filter included in the beat frequency tracking filter of the radar device according to the first embodiment of the present invention.

Referring to FIG. 3, the up-chirp tracking filter 23 includes a prediction unit 231, a beat frequency converter 232, a correlation unit 233, and a smoothing unit 234. A configuration and operation of the down-chirp tracking filter 24 are identical with those of the up-chirp tracking filter 23.

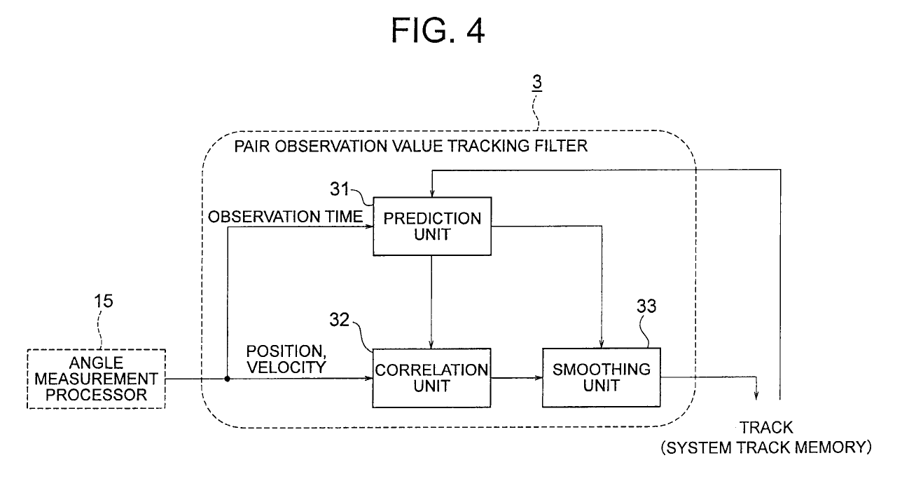

FIG. 4 is a block diagram illustrating a configuration of the pair observation value tracking filter of the radar device according to the first embodiment of the present invention.

Referring to FIG. 4, the pair observation value tracking filter 3 includes a prediction unit 31, a correlation unit 32, and a smoothing unit 33.

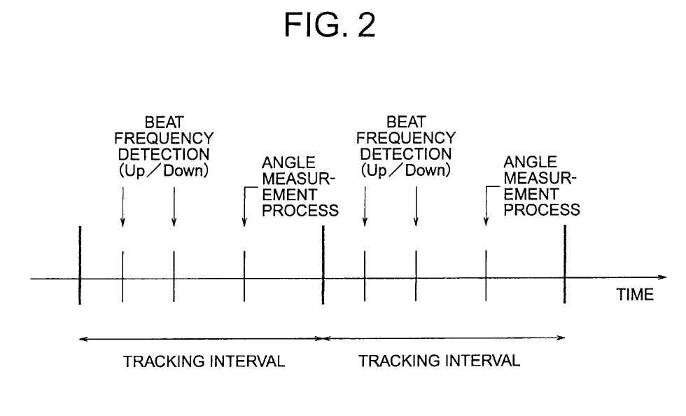

Next, an operation of the radar device according to the first embodiment of the present invention is described with reference to the drawings. FIG. 2 is a diagram illustrating an observation schedule of the radar device according to the first embodiment of the present invention.

The receiver 11 included in the signal processor 1 receives, as a reception signal, a signal obtained by reflecting, by a target, a transmission signal having a frequency periodically increased or decreased with a given modulation width. The A/D converter 12 converts a beat signal with an intermediate frequency, which is output from the receiver 11, into a digital signal.

The beat frequency detector 13 performs frequency analysis through a fast Fourier transform (FFT). That is, the beat frequency detector 13 mixes the reception signal and the transmission signal together to generate a beat signal. The beat frequency detector 13 then obtains a first beat frequency distribution according to the beat signal being in an up-chirp state in which a frequency of the transmission signal increases, and specifies a first frequency peak of the first beat frequency distribution. The beat frequency detector 13 further obtains a second beat frequency distribution according to the beat signal being in a down-chirp state in which the frequency of the transmission signal decreases, and specifies a second frequency peak of the second beat frequency distribution.

A frequency U(t)i of the beat signal in the up-chirp state and a frequency D(t)j of the beat signal in the down-chirp state are extracted. Herein, i and j are representative of the number of peaks obtained by the beat frequency detector 13. It is presumed that to each of the beat frequencies is allocated a time (hereinafter, referred to as “beat frequency observation time”) at which the beat frequency is obtained. As illustrated in FIG. 2, times allocated to the beat frequency, an angle calculated by the angle measurement processor 15, and target information input to the pair observation value tracking filter 3 are different from each other. The output order has been known in advance. Herein, a period during which a pair observation value is input to the pair observation value tracking filter 3 (the same is applied to a period during which a system track is output) is referred to as a “tracking period (tracking interval)”.

The beat frequency pair selector 14 produces the pair observation value of the first frequency peak of the first beat frequency distribution and the second frequency peak of the second beat frequency distribution to calculate a range and a Doppler velocity with respect to the target.

The angle measurement processor 15 calculates an angle of the target on the basis of the pair observation value from the beat frequency pair selector 14.

The beat frequency obtained by the beat frequency detector 13 is output to the beat frequency tracking filter 2. The beat frequency tracking filter 2 updates, with the use of an existing track, a position and velocity of the track on the basis of the first frequency peak of the first beat frequency distribution or the second frequency peak of the second beat frequency distribution.

The observation value output determination unit 21 included in the beat frequency tracking filter 2 determines whether the input beat frequency has been obtained in the up-chirp state or the down-chirp state, outputs an up-beat frequency to the up-chirp tracking filter 23, and outputs a down-beat frequency to the down-chirp tracking filter 24.

As illustrated in FIG. 3, the up-chirp tracking filter 23 receives the beat frequency being in the up-chirp state, executes a tracking process on the received beat frequency, and updates the position and the velocity of the target. The tracking process uses an extended Kalman filter or the like because a relational expression of the received beat frequency, the position, and the velocity of the target is of a nonlinear expression.

First, the prediction unit 231 calculates a predicted state vector X_{k|k-1} represented by the following expressions (2) and (3) with the use of a updated state vector X_{k-1|k-1} represented by the following expression (1) for the existing track (system track or sub track) output from the system track memory 5 (or the sub track memory 25). The prediction unit 231 calculates a state prediction covariance matrix P_{k|k-1} represented by the following expression (4) with the use of a updated state covariance matrix P_{k-1|k-1} and a drive noise covariance matrix Qₖ₋₁. A state transition matrix Φₖ₋₁ used for calculation is calculated through the following expression (5) with the use of a difference Δtₖ₋₁(=t(k)−t(k−1)) from a time t(k) allocated to the beat frequency newly supplied by the observation value output determination unit 21, which is represented by the following expression (6).

$$\begin{matrix}{x}_{k - 1 \vert k - 1} = \begin{matrix}[ {x}_{k - 1 \vert k - 1} & {y}_{k - 1 \vert k - 1} & {\dot{x}}_{k - 1 \vert k - 1} & {{\dot{y}}_{k - 1 \vert k - 1} ]}^{T}\end{matrix} & ( 1 ) \\ {x}_{k \vert k - 1} = {Φ}_{k - 1} {x}_{k - 1 \vert k - 1} & ( 2 ) \\ {x}_{k \vert k - 1} = [ \begin{matrix}{x}_{k \vert k - 1} & {y}_{k \vert k - 1} & {\dot{x}}_{k \vert k - 1} & {{\dot{y}}_{k \vert k - 1} ]}^{T}\end{matrix} & ( 3 ) \\ {P}_{k \vert k - 1} = {Φ}_{k - 1} {P}_{k - 1 \vert k - 1} {{Φ}_{k - 1}}^{T} + {Q}_{k - 1} & ( 4 ) \\ {Φ}_{k} = [ \begin{matrix}{I}_{2 \times 2} & Δ {t}_{k} \cdot {I}_{2 \times 2} \\ 0 & {I}_{2 \times 2}\end{matrix} ] & ( 5 ) \\ Δ {t}_{k} = {t}_{k + 1} - {t}_{k} & ( 6 )\end{matrix}$$

The beat frequency converter 232 converts the track into a beat frequency predicted value f^{u}_{k|k-1} and a state prediction variance P^{u}_{k|k-1}, as represented by the following expressions (7) to (11).

$$\begin{matrix}{f}_{k \vert k - 1}^{u} = \frac{2 B}{cT} {R}_{p} + \frac{2 {f}_{0}}{c} {V}_{p} & ( 7 ) \\ {R}_{p} = \sqrt{{x}_{k \vert k - 1}^{2} + {y}_{k \vert k - 1}^{2}} & ( 8 ) \\ {V}_{p} = \frac{{x}_{k \vert k - 1} {\dot{x}}_{k \vert k - 1} + {y}_{k \vert k - 1} {\dot{y}}_{k \vert k - 1}}{\sqrt{{x}_{k \vert k - 1}^{2} + {y}_{k \vert k - 1}^{2}}} & ( 9 ) \\ {H}_{k}^{u} = [ \begin{matrix}\frac{\partial {f}_{k \vert k - 1}^{u}}{\partial {x}_{k \vert k - 1}} & \frac{\partial {f}_{k \vert k - 1}^{u}}{\partial {y}_{k \vert k - 1}} & \frac{\partial {f}_{k \vert k - 1}^{u}}{\partial {\dot{x}}_{k \vert k - 1}} & \frac{\partial {f}_{k \vert k - 1}^{u}}{\partial {\dot{y}}_{k \vert k - 1}} ]\end{matrix} & ( 10 ) \\ {P}_{k \vert k - 1}^{u} = ( {H}_{k}^{u} ) {{P}_{k \vert k - 1} ( {H}_{k}^{u} )}^{T} & ( 11 )\end{matrix}$$

The correlation unit 233 performs a correlation process of the beat frequency predicted value and the beat frequency. The correlation unit 233 first determines whether or not the observation value f^{u}ₒ of the beat frequency in the up-chirp state at the time tₖ when the observation value output determination unit 21 executes the output satisfies an inequality represented by the following expression (12). In the expression (12), d^{u} is a determination threshold value, and S^{u} is a residual variance of the target which is defined by the following expression (13). In the expression (13), Aₖ is an measurement error variance.

$$\begin{matrix}\frac{{( {f}_{o}^{u} - {f}_{k \vert k - 1}^{u} )}^{2}}{{S}^{u}} \leq {d}^{u} & ( 12 ) \\ {S}^{u} = {P}_{k \vert k - 1}^{u} + {A}_{k} & ( 13 )\end{matrix}$$

When there is no beat frequency observation value satisfying the expression (12) at all, the correlation unit 233 does not output the beat frequency to the smoothing unit 234, and the smoothing unit 234 executes a process (hereinafter referred to as “memory track process”) of replacing the updated state value with a predicted value as represented by the following expressions (14) and (15).

x_{k|k}=x_{k|k-1} (14)

P_{k|k}=P_{k|k-1} (15)

On the other hand, when there is a beat frequency observation value satisfying the expression (12) (when there is a correlation), the correlation unit 233 outputs the beat frequency observation value to the smoothing unit 234, and updates the updated state value of the target. Further, when a plurality of beat frequency observation values satisfy the expression (12), the correlation unit 233 updates the updated state value of the target with the use of a normal correlation algorithm such as nearest neighbor (NN). For example, the updating expression for the updated state value is represented by the following expression (16). In the expression (16), a gain matrix K^{u}ₖ is calculated by using a theoretical formula such as an extended Kalman filter generally known. Flag^{EKF} has 0 as an initial value, and adds 1 only when there is a correlation, as represented by the following expression (17).

x_{k|k}=x_{k|k-1}+Kₖ^{u}{fₒ^{u}−f_{k|k-1}^{u}} (16)

Flag^{EKF}=Flag^{EKF}+1 (17)

The smoothing unit 234 outputs the updated state vector, the updated state variance, and the time to the sub track memory 25, and regards the updated state vector and the updated state variance as a sub track. The sub track memory 25 outputs the sub track to the track input determination unit 22.

Subsequently, the track input determination unit 22 outputs the sub track to the down-chirp tracking filter 24. The configuration and operation of the down-chirp tracking filter 24 are identical with those of the up-chirp tracking filter 23 as described above. With a superscript u of a state vector in the expressions (7) to (11) being changed to d, the down-chirp tracking filter 24 operates in the same manner. Therefore, detailed description thereof is omitted.

Assuming that the signal processing time is different as illustrated in FIG. 2, the down-chirp tracking filter 24 normally performs the processing of the prediction unit 241 by using the time difference Δtₖ (expression (6)) of the signal processing. There arises no problem even when the processing of the prediction unit 241 is performed at Δtₖ=0 assuming that the up-beat frequency and the down-beat frequency are observed at the same time in the tracking period of the system track.

The beat frequency tracking filter 2 updates the sub track with the aid of the beat frequency obtained till the subsequent tracking period. Even when the order of the up-chirp and the down-chirp is replaced with each other in the signal processor 1, it is possible to perform the tracking process according to the order of the input beat frequency. Described above is the processing of the beat frequency tracking filter 2.

Subsequently, processing of the pair observation value tracking filter 3 is described. The pair observation value tracking filter 3, as illustrated in FIG. 4, receives a pair observation value having the range, velocity, and angle information which is output from the angle measurement processor 15, and performs the tracking process. That is, the pair observation value tracking filter 3 updates the position and velocity of the track based on the observation value including the range, the Doppler velocity, and the angle with the aid of the existing track. The tracking process uses a linear Kalman filter or the like because the input range, velocity, and angle are subjected to coordinate conversion to obtain the observation values of the position and velocity. In this example, information on the paired up-beat frequency and down-beat frequency is also allocated to the pair observation value.

An operation of the prediction unit 31 is identical with that of the prediction unit 231 of the up-chirp tracking filter 23, and therefore description thereof is omitted. The correlation unit 32 performs the correlation process of the predicted value output from the prediction unit 31 and the pair observation value output from the angle measurement processor 15. The correlation unit 32 first determines whether or not a pair observation value zₖ at the time tₖ satisfies an inequality of the following expression (18). In the expression (18), d^{LKF} is a determination threshold value, and S is a residual covariance of the target which is defined in the following expression (19). In the expression (19), Aₖ is an measurement error covariance.

(zₖ−Hₖx_{k|k-1})^{T}S_{k|k-1}⁻¹(zₖ−Hₖx_{k|k-1})≦d^{LKF} (18)

S_{k|k-1}=HₖP_{k|k-1}Hₖ^{T}+Aₖ (19)

H=I_{4×4} (20)

zₖ=[Rₒₖ sin θₒₖRₒₖ cos θₒₖ\dot{R}ₒₖ sin θₒₖ\dot{R}ₒₖ cos θₒₖ]^{T} (21)

When it is determined that there is no correlation, the correlation unit 32 does not output the pair observation value to the smoothing unit 33, and the smoothing unit 33 executes the memory track process represented by the expressions (14) and (15). On the other hand, when it is determined that there is a correlation, the correlation unit 32 outputs the pair observation value to the smoothing unit 33 to update the updated state value of the target. The smoothing expression is represented by the following expression (22). A gain matrix Kₖ is calculated by using a theoretical formula such as a Kalman filter generally known. Flag^{LKF} has 0 as an initial value, and adds 1 only when there is a correlation, as represented by the following expression (23).

x_{k|k}=x_{k|k-1}+Kₖ{zₖ−Hₖx_{k|k-1}} (22)

Flag^{LKF}=Flag^{LKF}+1 (23)

The pair observation value tracking filter 3 outputs the updated state vector, the updated state covariance matrix, and information on the paired up-beat frequency and down-beat frequency allocated to the pair observation value correlated to the track to the integration/selection unit 4.

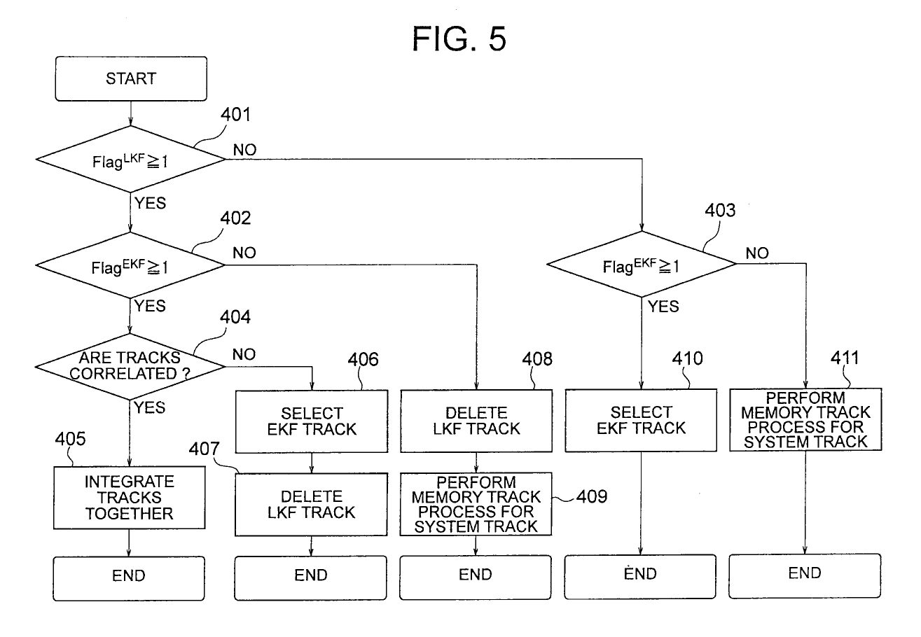

Next, an operation of the integration/selection unit 4 is described with reference to FIGS. 5, 6, and 7. FIGS. 5, 6, and 7 are flowcharts illustrating the operation of the integration/selection unit 4, respectively. For distinction of track, the output track (hereinafter referred to as “EKF track”) of the beat frequency tracking filter 2 is followed by a superscript EKF, the output track (hereinafter referred to as “LKF track”) of the pair observation tracking filter 3 is followed by a superscript LKF, and the system track finally registered is followed by a superscript SYS. The integration/selection unit 4 integrates the tracks of the pair observation value tracking filter 3 and the beat frequency tracking filter 2, or selects one of those tracks to provide the system track. The system track memory 5 stores the system track therein.

The integration/selection unit 4 first performs checking of the EKF track and the LKF track (Steps 401 to 403). In this time, when both of those tracks are memory tracks, the integration/selection unit 4 regards the system track as a memory track, and registers the EKF track as the system track in the system track memory 5 (Step 411).

x_{k|k}^{SYS}=x_{k|k}^{EKF} (24)

P_{k|k}^{SYS}=P_{k|k}^{EKF} (25)

When the LKF track exists, and the EKF track is a memory track, the integration/selection unit 4 assumes that the LKF track is updated by the observation value of the erroneous pair, and deletes the LKF track (Step 408). Further, the integration/selection unit 4 registers the EKF track in the system track memory 5 as the system track (Step 409). When the LKF track is a memory track, and the EKF track exists, the integration/selection unit 4 registers the EKF track in the system track memory 5 as the system track (Step 410).

When both of the EKF track and the LKF track exist, the integration/selection unit 4 evaluates the adequacy of the track. First, the integration/selection unit 4 performs the determination of correlation between the tracks through the following expression (26) (Step 404). In this case, x and P output from the respective tracks correspond to x_{k|k} and P_{k|k}, respectively. In the expression (26), d^{TRK} represents the determination threshold value.

(x^{LKF}−x^{EKF})^{T}(P^{LKF}+P^{EKF})⁻¹(x^{LKF}−x^{EKF})≦d^{TRK} (26)

When the expression (26) is not satisfied in the above-mentioned correlation determination, the integration/selection unit 4 assumes that the tracks are of no correlation, and registers the EKF track in the system track memory 5 as the system track (Step 406). Then, the integration/selection unit 4 deletes the LKF track (Step 407).

When the expression (26) is satisfied, the integration/selection unit 4 assumes that the tracks are of correlation, and integrates the tracks together (Step 405). As a method involving integrating the tracks together, the integration/selection unit 4 integrates the tracks together through a covariance intersection technique, taking a color property into consideration, for example, as represented by the following expressions (27) and (28). The integration/selection unit 4 registers the integrated track in the system track memory 5 as the system track. In this case, a state vector x^{SYS}_{k|k} and the updated state covariance matrix P^{SYS}_{k|k} of the system track are given by the following expressions (27) and (28), respectively. In the expressions (27) and (28), ω represents a parameter. Further, the integration/selection unit 4 also registers, in the system track memory 5, the information on the pair of up-beat frequency and down-beat frequency which are allocated to the pair observation value correlated with the track of the pair observation value tracking filter 3.

x_{k|k}^{SYS}=P_{k|k}^{SYS}[ω{P^{LKF}}⁻¹x^{LKF}+(1−ω){P^{EKF}}⁻¹x^{EKF}] (27)

P_{k|k}^{SYS}=[ω{P^{LKF}}⁻¹+(1−ω){P^{EKF}}⁻¹]⁻¹ (28)

Further, there may be applied a least square integration method as represented by the following expressions (29) and (30) though the color property is not considered. The method has no need to set the parameter ω.

x_{k|k}^{SYS}=P_{k|k}^{SYS}[{P^{LKF}}⁻¹x^{LKF}+{P^{EKF}}⁻¹x^{EKF}] (29)

P_{k|k}^{SYS}=[{P^{LKF}}⁻¹+{P^{EKF}}⁻¹]⁻¹ (30)

For the purpose of reducing a calculation load, there is a weighting and integrating method using a trace of the updated state covariance matrix of the track as represented by the following expression (31) (it is assumed that the trace of a matrix A is tr(A)). The method has no need to calculate an inverse matrix though the updated state covariance matrix of the system track cannot be calculated.

$${x}_{k \vert k}^{SYS} = \frac{tr ( {P}^{EKF} )}{tr ( {P}^{LKF} ) + tr ( {P}^{EKF} )} {x}^{LKF} + \frac{tr ( {P}^{LKF} )}{tr ( {P}^{LKF} ) + tr ( {P}^{EKF} )} {x}^{EKF} \qquad ( 31 )$$

Further, with an aim to suppress the calculation load, there are a weighting and integrating method using a predetermined parameter a(0≦a≦1) as represented by the following expression (32), and a weighting and integrating method depending on the update status of the track, as represented by the following expression (33). In this case, n_{LKF} in the expression (33) represents the number of times by which the tracks are input to the integration/selection unit 4 without the LKF track becoming the memory track during N samplings in the past from the present. In the case of the EKF track, n_{LKF} is replaced with n_{EKF}. In particular, when a simple tracking filter such as an α−β filter is employed as the tracking filter, the method is effective with no need to update the updated state covariance.

$$\begin{matrix}{x}_{k \vert k}^{SYS} = {ax}^{LKF} + ( 1 - a ) {x}^{EKF} & ( 32 ) \\ {x}_{k \vert k}^{SYS} = \frac{{n}_{LKF}}{{n}_{LKF} + {n}_{EKF}} {x}^{LKF} + \frac{{n}_{EKF}}{{n}_{LKF} + {n}_{EKF}} {x}^{EKF} & ( 33 )\end{matrix}$$

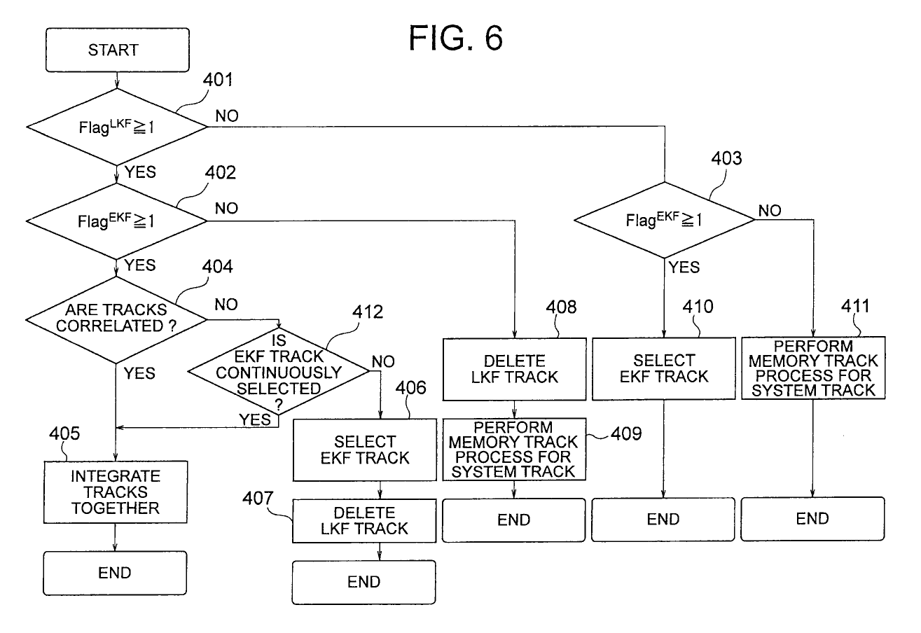

When the integration/selection unit 4 continuously selects the EKF track because of no correlation between the tracks in Step 404 of FIG. 5, there is a fear that the tracking precision deteriorates because of no use of the angle observation value. For that reason, as illustrated in FIG. 6, when the number of times by which the EKF track is continuously selected exceeds a threshold value, there may be employed a method of integrating the tracks through the track integrating technique (Steps 412 and 405) as represented by the above-mentioned expressions (27) to (33).

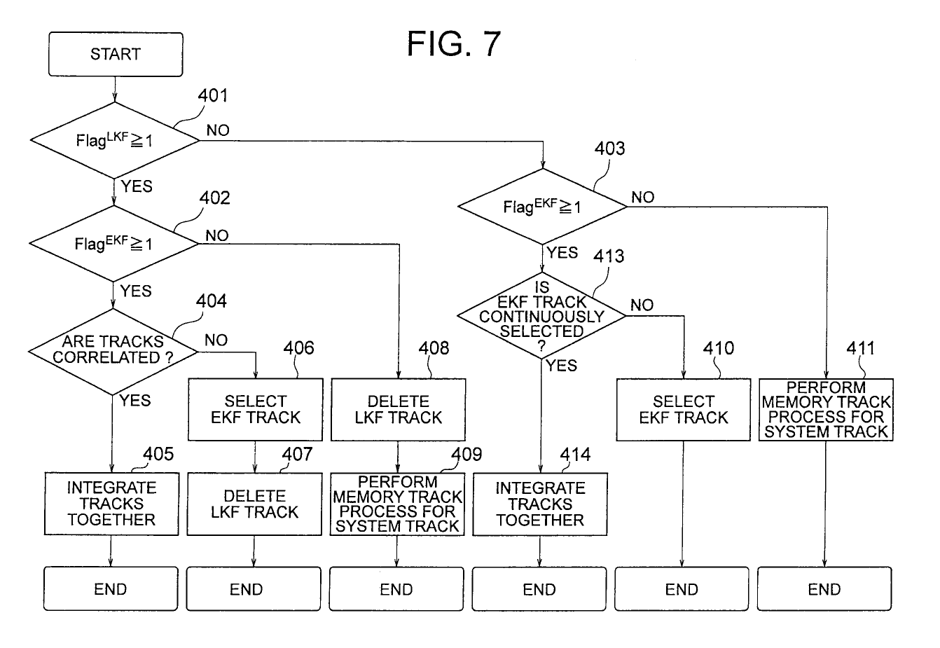

Further, when the LKF track is the memory track in Step 403 of FIG. 5, and the EKF track is continuously selected, there is a fear that the tracking precision deteriorates because of no use of the angle observation value. For that reason, as illustrated in FIG. 7, when the number of times by which the EKF track is continuously selected exceeds a threshold value, there may be employed a method of integrating the tracks through the track integrating technique (Steps 413 and 414) as represented by the above-mentioned expressions (27) to (33). Further, the processing of FIGS. 6 and 7 can be used in combination. Described above is the operation of the integration/selection unit 4.

The abnormal value determination unit 6 regards the pair observation value input from the angle measurement processor being not identical with the information on the up-beat frequency and the down-beat frequency which are input from the system track memory 5, as an abnormal value, and does not start tracking. That is, when the pair observation value from the angle measurement processor 15 is not identical with the system track, the abnormal value determination unit 6 regards the pair observation value as the abnormal value, and does not start tracking with respect to the abnormal value. In addition, the abnormal value determination unit 6 may output, to the beat frequency pair selector 14 within the signal processor 1, the up- and down-frequency pair allocated to the pair observation value used for the system track so as to be paired preferentially.

As described above, according to the first embodiment, in the radar device with the FMCW radar, the tracking precision can be improved as compared with the conventional radar device with the FMCW radar to thereby enable a reduction in occurrence of the erroneous track, by means of the integration/selection unit 4 for integrating the tracks together or selecting one of the tracks, and the abnormal value determination unit 6 for determining the erroneous pair based on the pair correlated with the track. In this case, there are used the beat frequency tracking filter 2 directly receiving the beat frequencies obtained in the up-chirp state and the down-chirp state to update the position and the velocity of the target, and the pair observation value tracking filter 3 receiving the range, the Doppler velocity, and the angle of the target, which are obtained from the pair of the up-chirp state and the down-chirp state to update the position and the velocity of the target, together.

Further, according to the first embodiment, in the radar device with the FMCW radar, the abnormal value determination unit 6 outputs, to the signal processor 1, the pair correlated with the track as a candidate that is preferentially paired, thereby enabling the occurrence of the erroneous pair to be reduced.

Further, according to the first embodiment, in the radar device with the FMCW radar, the tracking precision can be enhanced by the integration/selection unit 4 selecting the track small in residual error when the track of the beat frequency tracking filter 2 is continuously selected even if the tracks of the pair observation value tracking filter 3 and the beat frequency tracking filter 2 are not correlated with each other.

Further, according to the first embodiment, in the radar device with the FMCW radar, when the track of the beat frequency tracking filter 2 is continuously selected, and there is no observation value correlated by the pair observation value tracking filter 3, the integration/selection unit 4 integrates a predicted track of the track of the pair observation value tracking filter 3 and the track of the beat frequency tracking filter 2 together, thereby enabling the target tracking precision to be enhanced.

Further, according to the first embodiment, in the radar device with the FMCW radar, the integration/selection unit 4 executes weighting and integration with the use of a predetermined parameter when integrating the tracks together, thereby enabling the calculation load to be reduced.

Further, according to the first embodiment, in the radar device with the FMCW radar, the integration/selection unit 4 executes weighting and integration through the covariance intersection technique when integrating the tracks together, taking the color property into consideration, thereby enabling the tracking precision to be ensured.

Further, according to the first embodiment, in the radar device with the FMCW radar, the integration/selection unit 4 executes weighting and integration through the least square integration method when integrating the tracks together, thereby enabling the tracking precision to be ensured without setting the parameter.

Further, according to the first embodiment, in the radar device with the FMCW radar, the integration/selection unit 4 executes weighting and integration with the use of trace of the updated state covariance matrix of each track when integrating the tracks together, thereby enabling the calculation load to be reduced.

Further, according to the first embodiment, in the radar device with the FMCW radar, the integration/selection unit 4 executes weighting and integration with the use of the number of updating times of the tracking for each track when integrating the tracks together, thereby enabling the calculation load to be reduced.

### Second Embodiment

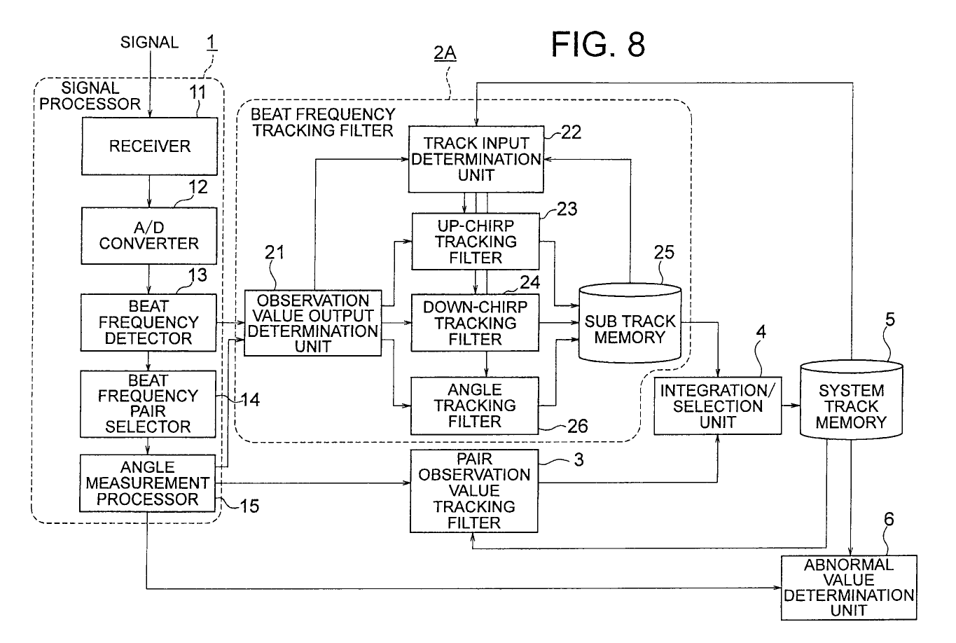

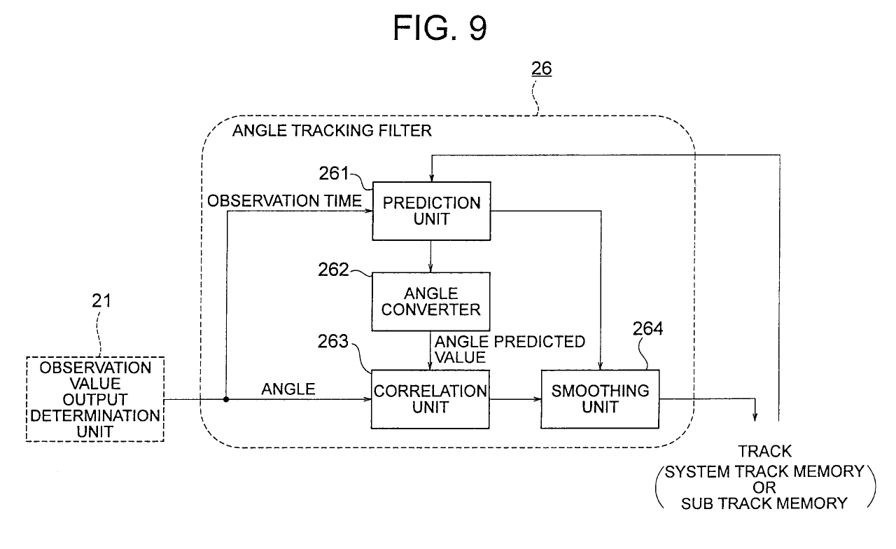

A radar device according to a second embodiment of the present invention is described with reference to FIGS. 8 and 9. FIG. 8 is a block diagram illustrating a configuration of the radar device according to the second embodiment of the present invention.

Referring to FIG. 8, the radar device according to the second embodiment of the present invention is configured to add an angle tracking filter 26 inside a beat frequency tracking filter 2A.

FIG. 9 is a block diagram illustrating a configuration of the angle tracking filter of the radar device according to the second embodiment of the present invention.

Referring to FIG. 9, the angle tracking filter 26 includes a prediction unit 261, an angle converter 262, a correlation unit 263, and a smoothing unit 264.

Next, an operation of the radar device according to the second embodiment of the present invention is described with reference to the drawings.

The radar device according to the second embodiment is configured to input the angle of the pair observation value to the beat frequency tracking filter 2A to execute the tracking process.

The angle tracking filter 26, as illustrated in FIG. 9, receives the angle output from the observation value output determination unit 21 to perform the tracking process. An operation of the prediction unit 261 included in the angle tracking filter 26 is identical with that of the prediction unit 231 included in the up-chirp tracking filter 23, and therefore description thereof is omitted.

The angle converter 262 converts the track into an angle predicted value θ_{k|k-1} and a state prediction variance P^{θ}_{k|k-1}, as represented by the following expressions (34) to (36).

$$\begin{matrix}{θ}_{k \vert k - 1} = {tan}^{- 1} ( \frac{{x}_{k \vert k - 1}}{{y}_{k \vert k - 1}} ) & ( 34 ) \\ {P}_{k \vert k - 1}^{θ} = ( {H}_{k}^{θ} ) {{P}_{k \vert k - 1} ( {H}_{k}^{θ} )}^{T} & ( 35 ) \\ {H}_{k}^{θ} = [ \begin{matrix}\frac{\partial {θ}_{k \vert k - 1}}{\partial {x}_{k \vert k - 1}} & \frac{\partial {θ}_{k \vert k - 1}}{\partial {y}_{k \vert k - 1}} & \frac{\partial {θ}_{k \vert k - 1}}{\partial {\dot{x}}_{k \vert k - 1}} & \frac{\partial {θ}_{k \vert k - 1}}{\partial {\dot{y}}_{k \vert k - 1}} ]\end{matrix} & ( 36 )\end{matrix}$$

The correlation unit 263 performs a process of correlating the predicted value output from the angle converter 262 with the pair observation value output from the observation value output determination unit 21. First, the correlation unit 263 determines whether or not the pair observation value zₖ at the time tₖ satisfies an inequality of the following expression (37). In the expression (37), d^{θ} is a determination threshold value, and S^{θ} is a residual covariance of the target which is defined in the following expression (38).

$$\begin{matrix}\frac{{( {θ}_{o} - {θ}_{k \vert k - 1} )}^{2}}{{S}^{θ}} \leq {d}^{θ} & ( 37 ) \\ {S}^{θ} = {P}_{k \vert k - 1}^{θ} + {A}_{k} & ( 38 )\end{matrix}$$

When it is determined that there is no correlation, the correlation unit 263 does not output the pair observation value to the smoothing unit 264, and the smoothing unit 264 executes the memory track process represented by the above-mentioned expressions (14) and (15).

On the other hand, when it is determined that there is a correlation, the correlation unit 263 outputs the angle observation value to the smoothing unit 264, and updates the updated state value of the target.

x_{k|k}=x_{k|k-1}+Kₖ^{θ}{θₒ−θ_{k|k-1}} (39)

Flag^{EKF}=Flag^{EKF}+1 (40)

The smoothing unit 264 outputs the updated state vector, the updated state variance, and the time to the sub track memory 25, and regards the updated state vector and the updated state variance as a sub track. The sub track memory 25 outputs the sub track to the track input determination unit 22. Other processing is identical with that in the above-mentioned first embodiment, and therefore description thereof is omitted.

As described above, according to the second embodiment, in the radar device with the FMCW radar, the beat frequency tracking filter 2A directly receives the angle of the pair observation value in addition to the up-chirp and the down-chirp to update the position and the velocity of the target, thereby enabling the tracking precision to be improved.

### Third Embodiment

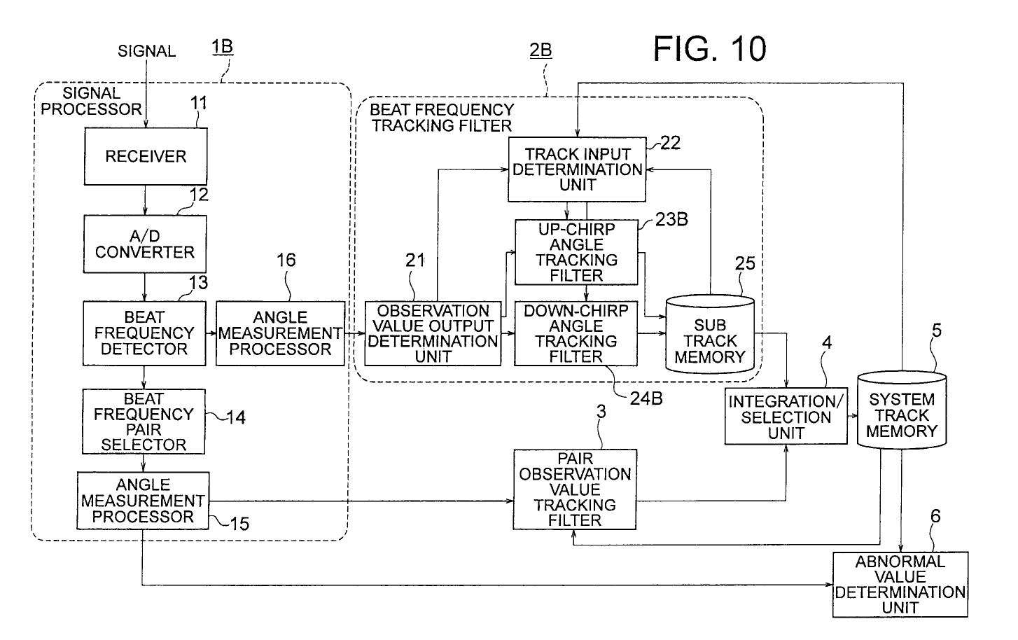

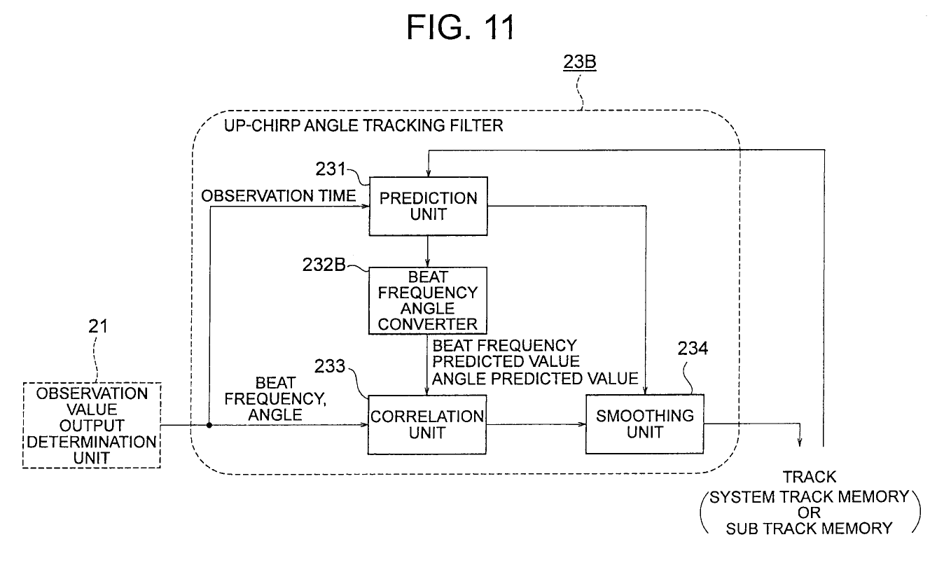

A radar device according to a third embodiment of the present invention is described with reference to FIGS. 10 and 11. FIG. 10 is a block diagram illustrating a configuration of the radar device according to the third embodiment of the present invention.

Referring to FIG. 10, the radar device according to the third embodiment of the present invention is configured to add the same angle measurement processor 16 as the angle measurement processor 15 inside a signal processor 1B. Further, the radar device is configured to add an up-chirp angle tracking filter 23B and a down-chirp angle tracking filter 24B instead of the up-chirp tracking filter 23 and the down-chirp tracking filter 24 inside a beat frequency tracking filter 2B.

FIG. 11 is a block diagram illustrating a configuration of the up-chirp tracking filter of the radar device according to the third embodiment of the present invention.

Referring to FIG. 11, the up-chirp angle tracking filter 23B includes the prediction unit 231, a beat frequency angle converter 232B, the correlation unit 233, and the smoothing unit 234.

Next, an operation of the radar device according to the third embodiment of the present invention is described with reference to the drawings.

The radar device according to the third embodiment is configured to input, when angle measurement is executed every beat frequency to obtain an angle, the angle to the beat frequency tracking filter 2B to perform the tracking process.

As illustrated in FIG. 11, the up-chirp angle tracking filter 23B receives the beat frequency of the up-chirp state, which is output from the observation value output determination unit 21, and the angle allocated to that beat frequency, to perform the tracking process. An operation of the prediction unit 231 of the up-chirp angle tracking filter 23B illustrated in FIG. 11 is identical with that of the prediction unit 231 of the up-chirp tracking filter 23, and therefore description thereof is omitted.

The beat frequency angle converter 232B calculates the beat frequency predicted value f^{u}_{k|k-1} and the state prediction variance p^{u}_{k|k-1} thereof, and the angle predicted value θ_{k|k-1} and the state prediction variance p^{θ}_{k|k-1} thereof. Formula for calculation is omitted.

The correlation unit 233 performs a process of correlating the predicted value output from the beat frequency angle converter 232B with the beat frequency and the angle observation value. First, the correlation unit 233 determines whether or not the beat frequency observation value f^{u}ₒ and the angle observation value θₒ at the time tₖ satisfy an inequality of the following expression (41). In the expression (41), d is a determination threshold value, S^{u} is a residual covariance defined in the above-mentioned expression (13), and S^{θ} is a residual covariance defined in the above-mentioned expression (38).

$$\frac{{( {f}_{o}^{u} - {f}_{k \vert k - 1}^{u} )}^{2}}{{S}^{u}} + \frac{{( {θ}_{o} - {θ}_{k \vert k - 1} )}^{2}}{{S}^{θ}} \leq d \qquad ( 41 )$$

When it is determined that there is no correlation, the correlation unit 233 does not output the beat frequency and the angle observation value to the smoothing unit 234, and the smoothing unit 234 executes the memory track process represented by the above-mentioned expressions (14) and (15).

On the other hand, when it is determined that there is a correlation, the correlation unit 233 outputs the beat frequency and the angle observation value to the smoothing unit 234, and updates the updated state value of the target.

x_{k|k}=x_{k|k-1}+Kₖ^{u,θ}{zₒₖ−z_{k|k-1}} (42)

zₒₖ=[fₒ^{u}θₒ]^{T} (43)

z_{k|k-1}=[f_{k|k-1}^{u}θ_{k|k-1}]^{T} (44)

Flag^{EKF}=Flag^{EKF}+1 (45)

Next, the smoothing unit 234 outputs the updated state vector, the updated state variance, and the time to the sub track memory 25, and regards the updated state vector and the updated state variance as a sub track. The sub track memory 25 outputs the sub track to the track input determination unit 22. Other processing is identical with that in the above-mentioned first embodiment, and therefore description thereof is omitted.

As described above, according to the third embodiment, in the radar device with the FMCW radar, the beat frequency tracking filter 2B directly receives, in addition to the up-chirp and the down-chirp, the angle allocated thereto to update the position and the velocity of the target, thereby enabling the tracking precision to be improved.

What is claimed is:

1. A radar device, comprising:
a receiver that receives, as a reception signal, a signal obtained by reflecting a transmission signal periodically increased or decreased in frequency with a constant modulation width by a target;
a beat frequency detector configured to:
mix the reception signal and the transmission signal together to generate a beat signal;
obtain a first beat frequency distribution according to the beat signal being in an up-chirp state in which the frequency of the transmission signal increases, to thereby specify a first frequency peak of the first beat frequency distribution; and
obtain a second beat frequency distribution according to the beat signal being in a down-chirp state in which the frequency of the transmission signal decreases, to thereby specify a second frequency peak of the second beat frequency distribution;
a beat frequency pair selector that produces a pair observation value of the first frequency peak of the first beat frequency distribution and the second frequency peak of the second beat frequency distribution to calculate a range and a Doppler velocity with respect to the target;
an angle measurement processor that calculates an angle of the target based on the pair observation value;
a pair observation value tracking filter that updates a position and a velocity of a track according to the pair observation value including the range, the Doppler velocity, and the angle by means of an existing track;
a beat frequency tracking filter that updates the position and the velocity of the track according to one of the first frequency peak and the second frequency peak by means of the existing track;
an integration/selection unit that one of integrates the track of the pair observation value tracking filter and the track of the beat frequency tracking filter together, and selects one of the track of the pair observation value tracking filter and the track of the beat frequency tracking filter, as a system track;
a system track memory that stores the system track therein; and
an abnormal value determination unit that determines, when the pair observation value from the angle measurement processor is not identical with the system track stored in the system track memory, the pair observation value as an abnormal value, and starts no tracking with respect to the abnormal value.

2. A radar device according to claim 1, further comprising a beat frequency tracking filter that updates the position and the velocity of the track according to any one of the first frequency peak, the second frequency peak, and the angle included in the pair observation value by means of the existing track, instead of the beat frequency tracking filter that updates the position and the velocity of the track according to the one of the first frequency peak and the second frequency peak by means of the existing track.

3. A radar device according to claim 1, further comprising a beat frequency tracking filter that updates the position and the velocity of the track according to one of the first frequency peak and an angle allocated to the first frequency peak, and the second frequency peak and an angle allocated to the second frequency peak by means of the existing track, instead of the beat frequency tracking filter that updates the position and the velocity of the track according to the one of the first frequency peak and the second frequency peak by means of the existing track.

4. A radar device according to claim 1, wherein the abnormal value determination unit outputs, to the beat frequency pair selector, the pair observation value correlated with the system track as a candidate that is preferentially paired.

5. A radar device according to claim 1, wherein the integration/selection unit selects, when the track of the beat frequency tracking filter is continuously selected, the track with a small residual error even if the track of the pair observation value tracking filter and the track of the beat frequency tracking filter are not correlated with each other.

6. A radar device according to claim 1, wherein the integration/selection unit integrates a track obtained by predicting, with time, the track of the pair observation value tracking filter and the track of the beat frequency tracking filter together when the track of the beat frequency tracking filter is continuously selected, and when there is no pair observation value correlated by the pair observation value tracking filter.

7. A radar device according to claim 1, wherein the integration/selection unit executes weighting and integration with a predetermined parameter when integrating the track of the pair observation value tracking filter and the track of the beat frequency tracking filter together.

8. A radar device according to claim 1, wherein the integration/selection unit executes weighting and integration through a covariance intersection technique when integrating the track of the pair observation value tracking filter and the track of the beat frequency tracking filter together.

9. A radar device according to claim 1, wherein the integration/selection unit executes weighting and integration through a least square integration method when integrating the track of the pair observation value tracking filter and the track of the beat frequency tracking filter together.

10. A radar device according to claim 1, wherein the integration/selection unit executes weighting and integration by means of a trace of a updated state covariance matrix of each track when integrating the track of the pair observation value tracking filter and the track of the beat frequency tracking filter together.

11. A radar device according to claim 1, wherein the integration/selection unit executes weighting and integration by means of a number of updating times of tracking of each track when integrating the track of the pair observation value tracking filter and the track of the beat frequency tracking filter together.
